(19) United States
(12) Patent Application Publication
(10) Pub. No.: US 2026/0018875 A1
(43) Pub. Date: Jan. 15, 2026

(54) Electric Vehicle Charging Cable Management Safety System

(71) Applicant: CARBONYL CHEMICAL CONSULTING LLC, Fort Wayne, IN (US)

(72) Inventors: Jacob MAZO, Dyer, IN (US); Grigory MAZO, Dyer, IN (US); Stan Mazo, Las Vegas, NV (US)

(73) Assignee: CARBONYL CHEMICAL CONSULTING LLC, Fort Wayne, IN (US)

(21) Appl. No.: 18/770,642

(22) Filed: Jul. 11, 2024

Related U.S. Application Data
(63) Continuation-in-part of application No. PCT/US23/10616, filed on Jan. 11, 2023.

(51) Int. Cl. H02G 11/00; B60L 53/18; B60L 53/35

(52) U.S. Cl. CPC H02G 11/003; B60L 53/18; B60L 53/35

(57) ABSTRACT

A cable management system for the storage, deployment and support of an EV charging cable. The system is mounted at or near the source of power. The cable is electrically coupled to the power source and may be deployed and plugged into a port on the EV. The support system is mounted to a vertical support, and freely rotatably horizontal therefrom. The deployment end of the support system near the connector end of the holds the free end of the cable above the ground and includes a fixed length of free end of cord out of the body. The system may be expanded or contracted, in telescopic fashion, maintaining the free end of cord and charging head above the ground.

### CLAIM OF PRIORITY

The present continuation-in-part application includes subject matter disclosed in and claims priority to a PCT application entitled “Electric Vehicle Charging Cable Management Safety System” filed Jan. 11, 2023 and assigned Serial No. PCT/US23/010616, and to a provisional application entitled “Cable Management Safety Systems” filed Jan. 11, 2022 and assigned Ser. No. 63/298,602, both describing inventions made by the present inventors, herein incorporated by reference.

### BACKGROUND OF THE INVENTION

### 1. Field of the Invention

The present invention relates to electrical charging systems for electrical vehicles, and more particularly to a local power supply cable support and deployment system for charging vehicles.

### 2. Description of Related Prior Art

The use of various vehicles utilizing electric power in whole or in part for propulsion (EV's) has been becoming more widespread globally in the form of numerous vehicular powertrain designs, among which, broadly speaking, those often-termed battery electric vehicles and plug-in hybrid vehicles are becoming more common in use. As a result of deriving at least a significant part of their propulsive energy from sources of electricity external to the EV or being entirely dependent on same for all energy input, such vehicles use charging systems of various types, designs and capabilities. The variety of EV's includes those for personal transportation, commercial, industrial, public transport and various other uses. Such battery charging systems may be located outside the vehicle, or on board of one, or even both, depending on designs employed and the functions of vehicle being engaged in a given situation. One critical element of many systems for charging batteries on board such vehicles is a connection to the electric grid (or other power source) utilizing an electrically conductive cable, cord, or the like equipped with a connector (plug) for attaching to a vehicle; the details of all such arrangements are well known to the art of vehicle engineering. This connection system generally consists of several parts. The details of these various arrangements are also well known to those skilled in the art of designing systems related to vehicular propulsion using, in whole or in part, electric-powered means.

A large fraction of vehicles with at least partial electric propulsion utilizes a connection to the source of electricity via wired means well known to the art for charging onboard batteries, where the vehicle is provided with at least one receptacle (inlet) for receiving alternating current (AC) input via an electric cable, cord, or similar means. This is connected on its other end to an EVSE (electric vehicle service equipment) or its broad analog that is in turn connected to a power source. The cable or cord employed generally needs to be able to operate at relatively high voltages and amperages. In order to reach between EVSE and vehicle's inlet, the cord needs to be sufficiently long, but not beyond limits imposed by laws, rules and physical limitations. A typical length is between about 1.5 meters and about 7.5 meters (although it can sometimes be longer).

A number of vehicles, both extant and expected to be manufactured in the future, are further provided with at least one inlet for receiving direct current (DC) input via an electric cable, cord, or similar means at relatively very high voltages and amperages. A variety of designs known to the art are employed in such systems. It is also well understood that all operations involving handling, connecting, disconnecting, deploying, operating and stowing such high voltage/current equipment (AC and DC) must be conducted with adequate safety in all possible aspects at all times, and that making this an efficient process with lower costs, enhanced convenience and improved safety is highly beneficial.

An important element that makes EV's attractive to many users is the ability to charge them in and around their homes, and/or at other suitable locations of user's preference (e.g. commercial vehicle depots, workplaces, etc.). Cables, whether those employed as part of what are known as “rapid DC chargers” or what are sometimes termed in US “EVSE” in AC applications tend to be relatively large diameter, heavy, expensive, lacking in flexibility (both at room temperature and especially at low temperatures), and have a number of other properties well known to the art of making equipment for use with EV's. These are due to the requirement of being able to accomplish transfer of larger amounts of energy in shorter periods of time. Such cables are subject to frequent (multiple times per day) cycles of being deployed, used, and stored. This results in a relatively high number of such cycles being accumulated over several years for an EV power source. Intensive use results in significant mechanical damage of cable exterior from abrasion in routine or severe duty use, internal damage from being driven over by vehicles, and due to other factors. They are also subject to frequently being mounted outdoors, which subjects their materials to accelerated thermal degradation, damage and degradation induced by UV (ultraviolet) light and solar exposure, as well as accelerated wear due to being deployed and stored frequently while at excessively low and/or excessively high temperatures over extended periods of time. All this leads to shortening the life of a relatively costly unit. When the cable and/or its connector experience degradation, breakage, damage, failure, etc., users are additionally subjected to the inconvenience and high equipment and labor cost of having to have the cord (or entire device) replaced, as well as being unable to charge their vehicle(s) at device location while their device is being repaired or replaced.

Use of cables to charge vehicles with larger batteries in and around homes, garages, workplaces, parking lots, and the like becoming common only relatively recently. As a result, comparatively little attention has been paid to the hazards involved beyond the basic electricity safety aspects such as proper grounding, supply circuit capacities, prevention of movement by vehicle during charging process, and the like. Several important hazards created by cables used for EV charging remain. This is widely acknowledged by the broader EV charging industry, as illustrated by charging equipment manufacturer safety instructions, the series of white papers published by the CharIN Initiative, and by data collected and published by ESFI (Electrical Safety Foundation of Arlington, VA). CharIN in 2019 “Geometric Requirements for Charging Stations” and 2022 “Suggestions for improvement of EV charging connectors” white papers and ESFI publications “Prepare your home or business for electric vehicles” and “Electric vehicle charging survey” are incorporated herein by reference in their entirety. These issues, proposed safety directives, and the desirability of complying with all applicable safety instructions are known. However, manufacturers, industry groups and standardization bodies do not provide, or even propose, a practical means to achieve said compliance. The current highly problematic state of real-world EV charging safety and EV charging equipment failures are both further documented in ESFI's EV operator surveys and recommendations.

2023 ESFI survey documents a number of major problems. In no particular order:
high rate of injury to EV users; 8% report having been injured by electric shock when charging their EV
high “beyond repair” equipment failure rates: 20% of EVSEs failed completely, were beyond repair, and had to be replaced with new units
very high failure rates: 41% of EVSEs had to have repairs performed
low reliability (under 40% chance of failure-free operations, over 60% of EVSE units failed in some way)
the main source of failures (47%) is known to be plug (19%) and cable (28%) problems

ESFI publications (and EV charging equipment manufacturers) provide detailed instructions for safe and proper handling of EV cables and plugs, down to the exact way the cables must be wrapped when being stowed. None of these injuries should be happening when safety directives are properly followed. Most equipment failures are also preventable via the same means. However, due to a near total lack of suitable equipment to enable practical, convenient and easy safety compliance alongside proper equipment operation, in practice the instructions are generally not carried out at all, as is known to the art. Even EV manufacturers' advertising commonly shows cable handling that directly violates numerous safety directives promulgated by the same companies. As a result, safety, convenience and usability problems documented above persist, and are getting worse over time as charging equipment already installed in various locations ages and wears.

It is one goal of the instant invention that the handling of EV charging cables be made compliant with all relevant safety directives. Another goal is to make the compliance process more convenient in practice by automating it. Yet another goal of the instant invention is to provide a means to extend the likely lifetime and improve the functionality of the cables used in EV charging applications and similar activities. A number of additional benefits of the instant invention's practice are also obvious to one skilled in the art, such as improved resistance to cable theft, damage and vandalism, increased equipment uptime and lower operating costs, etc.

It is further desirable that a solution for these issues and those described elsewhere in this document be easily retrofitted to existing large numbers of vehicle charging systems at relatively low cost and with minimal disruption to customary operations. It is further highly desirable that no modifications be involved to the EV's intended to be charged.

One well known hazard (specifically mentioned in various safety directives) caused by EV charging cables is often termed “tripping hazard”. These are a well-known problem in a variety of contexts, and a significant amount of regulation worldwide exists to eliminate them from locations where people work, live, recreate, visit, etc. Their creation and maintenance are also well-known sources of legal liability for property owners, employers, and others in personal injury law. Various workplaces are known to be punished for violating rules against tripping hazards being present by OSHA, MSHA and other entities. However, to date, convenient and effective automated solutions that address the tripping hazard created by EV charging cables have not been known to the art. It is highly desirable to provide an invention that would reduce the creation of tripping hazards associated with EV ownership, operation, charging, etc. automatically.

A further personal injury risk exists associated with EV charging. Personnel connecting and disconnecting vehicle charging plugs to/from EV's can unintentionally drop them, and the plug could impact the user's foot, causing severe injuries. The risk of this type of accident for any specific instance of plug use is low. But an accident like this is inevitable, due to daily plug use by very large numbers of people over many years. This risk is significantly increased in adverse weather conditions outdoors (e.g. wet, cold, snow and ice-covered equipment, users wearing thick gloves, elderly, disabled, etc.) as is well known to the art of equipment handling and ergonomics. It is desirable to find a solution that would significantly reduce this risk.

EV charging equipment is used for comparatively longer periods, often for multiple hours at a time. The operators are frequently absent from the immediate vicinity of charging equipment while it's operating, and most of the time equipment is operated entirely unobserved by operator and without any human supervisory control. EV charging also often occurs inside people's homes while they are asleep (86% of EV owners have at least one home charger per ESFI). In light of this, an automatic means of compliance with applicable safety directives is highly desirable.

In light of all of the preceding, there appears to be both a need for solving the safety, cost, convenience, wear and related issues described above, and a lack of prior art device or system that could address all of the issues simultaneously.

It is also clear to those skilled in the art of providing designs of equipment for supporting, charging, and maintaining various electrically powered equipment, both personal and business/commercial/industrial, that the designs, methods, techniques and solutions disclosed herein are also highly adaptable to use with a variety of vehicles employing, in whole or in part, electric power and/or propulsion, such as those intended for use as various aircraft, watercraft, and other land and subterranean (e.g. mining) vehicles such as tractors, trucks, busses, carts, and others. Such designs and adaptations thereof using the instant disclosure are well within the scope of the instant invention.

### Prior Art Discussion

In general, the problems associated with EV charging as it is currently practiced and described, in part, above are well known. Industry best practices have also been enumerated and described in CharIN white papers, manufacturer safety directives, and ESFI publications. In response, and more generally as well, a number of prior art solutions have been suggested. Each of these prior art solutions has its significant merits; however, none to date provides a combination of benefits provided by the instant invention, especially from the point of view of safety and usability. While the safe cable management objectives in a variety of situations are successfully achieved by prior art, they are not usable for working with EV's in a convenient fashion, or have other significant disadvantages in numerous EV charging situations.

U.S. Pat. No. 10,896,774 to Stilwell et al. are not able to be used conveniently to move an EV charging cable's free end into suitable proximity to an EV's charging port because they are fixed into place. The devices of this prior art conspicuously lack any connection (aside from pipes, cables, etc. being carried) between the vertical stands.

U.S. Pat. No. 8,967,555 to Smith is not suitable for multiple deployments and storage activities on a daily basis, since they lack any means for moving while carrying electrical cable(s). The devices of this prior art require cables to be removed in order to be moved. While this is not an issue for their original intended application, namely safe management of electrical cables at construction sites and the like, it is a major difficulty when trying to adapt them to be used for EV charging applications. The devices of the prior art invention conspicuously lack any connection (aside from electric cables being carried) between the vertical stands.

U.S. Pat. No. 6,644,601 to Aussiker fails to address the safety and contamination issues posed by the “free” end of a cable not being controlled and being at risk of impact damage, contamination, etc. because it is directed at different applications of cables that are moved relatively rarely.

U.S. Pat. No. 10,518,656 to Morris et al. is not easily compatible with the standardized vehicle receptacles in common use now and anticipated to be used in future EV's.

U.S. Pat. No. 10,071,641 to C. Ricci are either both impractically expensive and inconvenient (for overhead electrical conductors) or simply impractically expensive for many uses (for robotic arms automatically finding and connecting relevant receptacles on vehicles).

U.S. Pat. No. 8,561,737 to S. Ichikawa is an example of an approach where the electric cable is made a part of the vehicle rather than a part of a charging system that is separate from an EV. However, this approach is problematic for a number of reasons well known to the art of vehicular construction; only some will be mentioned here by way of example. Because cables having high voltage and high current capacity in combination with significant length tend to have high weight and volume in such application, vehicles' utility in terms of weight carrying, object carrying, enjoyment and efficiency (the last two depend on vehicles being lower in weight) is thereby decreased by practicing the prior art invention. Such cables are also very expensive, raising the manufacturing cost of such vehicles in unaffordable ways.

U.S. Pat. No. 10,384,550 to R. Hollmig leaves open the issue of cable weight and cost in this case remains unaddressed; further, such a mounting system makes the process of replacing a worn-out charging cable a highly laborious undertaking; this makes such system impractically costly in addition to excessive weight. Excess weight and cost are well known to the art of automotive engineering as highly undesirable. Thus, it is desirable that charging cables are not made a part of an EV as shown in this prior art.

U.S. Pat. No. 9,975,443 to K. Jefferies et al. suffers from a number of disadvantages, of which the need for a new EVSE purchase and non-usability with existing EVSE's is a prominent one. Another prominent deficiency is a lack of any system to prevent user injury and/or connector damage from the connector accidentally being dropped by the user.

U.S. Pat. No. 9,054,539 to M. Muller et al. is not practical for longer EV charging cables of higher weights that are very popular (e.g. those having lengths well in excess of 20 feet/6 meters and having capacity to carry over 40 A of current). It also lacks any system to prevent user injury and/or connector damage from the connector accidentally being dropped by the user.

U.S. Pat. No. 9,487,100 to M. Hamrin et al. lacks any system to prevent user injury and/or connector damage from the connector accidentally being dropped by the user when the cable is significantly extended. Similarly, US 2017/0129355 to P. Fournier lacks any system to prevent user injury and/or connector damage from the connector accidentally being dropped by the user.

US 2013/0257373 to J. Mallon et al. is impractical in locations having relatively low overhead clearance (e.g. many parking structures, garages, etc.) and is especially impractical for use with longer cable lengths favored by many users (e.g. in excess of 20 feet/6 meters).

DE 102020202968A1 to M. Doring et al is incorporated herein by reference in their entirety. Although, this solution is not practical for longer and heavier cables that are often preferred by users (e.g. in excess of 20 feet/6 meters and intended for 40-50 A or higher) because of the distance, weight and loads involved. Further, this solution is only possible when both vehicle and EVSE are adapted to use such a device; this leaves extant vehicles and charging stations in a state of not being able to be retrofitted conveniently to use this solution. Further yet, this device requires that a generally straight line be always available between the source of electricity and the vehicle-mounted power receptacle, which is often not possible to achieve in a number of situations. The straight-line requirement of this prior art is highly inconvenient in practice where it is desirable to route a cable between or around various other items, obstacles, equipment, vehicle(s), etc.

WO 2019/096663A1 to T. Siaenen et al. requires that a generally straight line be available between the source of electricity and the vehicle-mounted power receptacle, which is often not possible to achieve in a number of situations. The straight-line requirement is highly inconvenient in practice as discussed above. Further, this prior art is impractical in locations having relatively low overhead clearance (e.g. many parking structures, garages, etc.) and is especially impractical for use with longer cable lengths favored by many users (e.g. in excess of 20 feet/6 meters) since the cable suspension device of prior art needs to be located in a relatively high position, and with longer cable lengths such heights become impractical for many installations.

DE 102017119930A1 to S. Schonherr et al. does not discuss the safety risks derived from such issues, only those of convenience. This prior art provides for assorted systems that locate the charging cable between an EVSE, DC charger, or their analogs and the free end of a charging cable equipped with a suitable connector. The systems are intended mostly for use in applications where the devices of the prior art are permanently mounted to a given facility and are difficult to move to a new one, which decreases their utility. The systems described further involve having this cable located in roughly two sections or more, where at least one section has the cable ascending into or onto the elevated structures disclosed by prior art that are located above the EV's being charged, and at least one other required section has the cable descending from the elevated structures by various means. This approach works well in certain applications; however, it is a very costly solution and one that does not fit into smaller spaces, especially those with lower vertical clearances. It is well known to the art of electrical engineering that electrical cables capable of carrying high voltage and/or high current are not only heavy and cumbersome as disclosed by prior art, but also extremely expensive per unit of length. Thus, designs that involve longer cable lengths than the minimum necessary are far more expensive to make and are thus very disadvantageous. Further yet, in many cases, there are strict legal restrictions on lengths of such cables for a variety of reasons. This prior art shows an example of over 4 meters of height difference between the structures being taught and the vehicle being charged. Thus, in cases of US legal maximum for such cables of about 7.6 meters (25 feet) and the cable descending vertically, that leaves only 3.6 meters of cable available for a “horizontal run” of cable. Also, this type of design is not amenable to easy retrofit for large numbers of existing EVSE's. As a result, this prior art is not practical for many applications such as homes, garages, commercial and/or public parking structures, etc. that would benefit from improved cable management, and is also not cost-effective in numerous use cases.

An additional device, named EVHover for use with EVSE's, has been marketed in the US since about 2022 and claims to be patent pending https://evhover.com. It contains a multiple stage (2-3) folding arm capable of being manually moved in horizontal plane only, with zip ties for suspending a cable therefrom, and a rigid wire arrangement at the end of arm for supporting an EV plug. The folding arm is intended to be attached to a vertical wall of the user's home, garage, or the like by user with a number of fasteners; the arm must be at a significant height to be well above the height of all users, any vehicles and their top-mounted attachments such as roof boxes. It is important to ensure the wall and fasteners used are sufficiently strong to support the weight of both arm and the cable it is supporting at maximum extension. The arm length is claimed to be about 6.5 feet (2 meters) long. The EVSE cable is suspended from a plurality of points on the stages of the folding arm using attachment devices (usually plastic zip ties). The system offered is strictly limited in weight of cable it can support to 10 lbs (4.5 kg). One important limitation of this type of device is that it is inefficient in use of legally-limited cable length, because EVSE cable length is “wasted” when the cable is ascending from EVSE to the arm, and is also “wasted” where EVSE cable is descending from its significant height to the EV charging port.

Another system of a generally similar nature has been offered in 2022 by Effortless Electric. https://www.effortlesselectric.com/cable-management/. This system is generally analogous to EVHover, but contains only a single stage arm. It is also equipped with a device to prevent the cable's end and its connector from impacting the floor or user's foot, in the form of a separate, additional metal retractable cable that is connected to the EVSE cable near its free end. One important limitation of this type of device is that it is inefficient in use of legally-limited cable length, because EVSE cable length is “wasted” when the cable is ascending from EVSE to the arm, and is also “wasted” where EVSE cable is descending from its significant height to the EV charging port. Also, like EVHover, this system requires very high overhead clearance to prevent problems when taller vehicles with roof-mounted equipment are involved. Such clearance is often not available at all, and where it is available, the design causes even more cable “waste” during the ascent and descent, making the system less useful.

Yet another system of a similar nature, called ChargeArm, has been marketed in the Netherlands at the company's web site https://chargearm.com/en/. This type of design requires a very long cable, while simultaneously having a very short reach; as marketed, the reach is only about 2.3 meters (about 7.5 feet) while requiring a cable that is at least about 7.5 meters (about 25 feet) long.

In light of difficulties in handling EV charger cables, automated systems have been proposed, such as US 2022/0194246A1 to Van den Weijde, suggesting a pedestal-mounted large hexapod system with computer control that automatically connects charging cable to, and disconnects the same from, an EV. However, such systems are well known to the art to be relatively costly and require a high degree of maintenance to remain in operation under adverse climatic conditions. As a result, such systems are only suitable to the subset of situations where the cost and maintenance obstacles are easily overcome; the systems also suffer from relatively short reach, resulting in very costly redesigns and rebuilding of charging facilities to accommodate them. They are very difficult to retrofit to existing charging infrastructure and take up a large amount of space that is often not available.

Bianco et al in US 2011/0074351 suffers from a major difficulty in that due to limits imposed by National Electrical Code, only about 25 feet of cable are available. When most of that distance is used up for cable ascent and descent, very little effective reach is possible, especially with higher overhead clearance applications necessary to accommodate many taller EVs, especially when roof-mounted accessories (e.g. boxes) are added thereto. In this application, each unit of distance of greater clearance “consumes” twice that length in cable, where one unit is “lost” ascending to the top of the structure above the EVs, and another is “lost” descending. Further, the prior art requires the use of electronic equipment and devices to operate. This makes the system much more expensive and less reliable, in an application where lower cost, more reliable, and all-mechanical systems are preferred for reasons well known to the art.

Ashley (GB2588758) may be more usable in certain countries with three phase 240 V AC systems in common use and sidewalks are very narrow, and at the same time where cable lengths are not as limited as US 240V split phase systems. In US, only about 7.5 meters of cable are available for use for compliance and physics reasons. As becomes clear from prior art illustrations, the system's reach with US cable length limitations is going to be undesirably short. One important aspect of the instant invention is usability in many countries, including those that have more strict cable length limitations.

EP3312045 to Kachouh describes a system for suspending the cable above an EV. This system requires a large amount of overhead clearance, which is often unavailable in garages. It also creates a cable loop that may present a strangulation hazard.

CN108128205 to Luoyang describes a pintle-mounted telescoping system for supporting a charging cable. However, it lacks provisions for plug drop safety, a critical feature that ensures user protection from injury by plugs that are dropped.

As a result, it becomes clear that additional new solutions that overcome the various deficiencies of prior art for improved cable management in a safe, lower cost and efficient manner with high reach and high performance in a variety of aspects (including cable use efficiency) are highly desirable. Also desirable is a set of solutions that avoids prior art's significant deficiencies enumerated above.

The new solutions need to be able to combine a number of required automated mechanical safety and convenience features with cable length use efficiency (i.e. lack of cable length “waste”) in a single unit; such a unit has not been heretofore taught or suggested, owing to perceived and real difficulty of creating a design embodying all the requirements simultaneously.

It is therefore an object of the present invention to provide a safe and reliable cable management system.

It is a further object of the present invention to provide a method of supplying power via a cable in a safe and reliable manner.

These and other objects of the present invention will become apparent to those skilled in the art as the description thereof proceeds.

### SUMMARY OF THE INVENTION

The present invention is directed to a system for electric energy transfer by means of at least one electrical conductor having improved safety, utility and convenience features comprising a means of conducting electricity such as via a suitable cable and its cable management system. An arm that may be rotated from a vertical support, such as a wall may include two slidably engaging bodies. The fixed body is fixed so far as its distance from the vertical support is fixed, and the body is preferably maintained in a vertical position. The fixed body preferably includes an inlet to allow the cord to enter from the power source and may have an open end to accept an extending body slidably engaged (preferably within) the fixed body, preferably in a telescoping fashion. The arm, with both bodies may be rotated relative the vertical support via a hinge on a hinge axis that may be flus or set somewhat apart from the vertical support. The cord may have a charging coupler, charging head, at the far end of the cord, or other system known in the art to couple with the charging port of the vehicle or charging target.

The fixed body may house one or a set of spools to handle and direct the cord within the fixed body. The spool preferably includes a first axis orthogonal the hinge axis. A second spool may have its own second axis, also orthogonal the hinge axis and parallel the first axis of the first spool. The cord may be set below the first spool and routed above the second spool. The first spool may be free to drop along a vertical route within the fixed body to maintain the location, position, and/or tension of the cord when the system is retracted, and the first spool may rise and drop within a vertical channel therein. The first spool may be biased downwards, as by a weight, spring or otherwise, so that it drops when system in contracted state, and can be lifted (to reduce the path length of cord within fixed body) when in extended mode.

The invention also includes the method of maintaining the cord in a safe manner, with the free end (and charging head) kept above the floor or ground level. The bodies are preferably hingedly coupled to a vertical support (e.g., wall or pole) via a hinge having a hinge axis. The fixed body is preferably coupled to the hinge, while the extending body is preferably slidably coupled with (preferably within) the fixed body. The cord may be set in and through the fixed body and passing out of the extending body. The length of free end of cord may be fixed, as is hang, out of the extending body. The length of the free end of the cord may be less than the height of a coupler fixing a relative height of a cord outlet from the extending body. The system can be stored by retracting the extending body back into the fixed body and folding the arms relative the vertical support out of the way, e.g. against or flush with the wall. The system can be accessed for use by rotating the system (horizontally) from the wall or vertical support may optionally extending the extending body out to reach the charging target. The rotation and extend gin the extending body, or retracting same, preferably does not alter the length of the free end of the cord out of the extending body.

### BRIEF DESCRIPTION OF THE FIGURES

The present invention will be described with greater specificity and clarity with reference to the following drawings, in which:

FIG. 1 illustrates a perspective view of the system in retracted state displayed perpendicularly from wall.

FIG. 2 illustrates a partially see-through side view of the system in retracted state displayed perpendicularly from wall.

FIG. 3 illustrates a perspective view of the system in extended state displayed perpendicularly from wall.

FIG. 4 illustrates a partially see-through side view of the system in extended state displayed perpendicularly from wall.

FIG. 5 illustrates a perspective view of the system in retracted state folded to flush or parallel with wall.

FIG. 6 illustrates a perspective view of the system in retracted state displayed perpendicularly from wall.

FIG. 7 illustrates a perspective view of the system in extended state displayed perpendicularly from wall.

### DETAILED DESCRIPTION OF THE PREFERRED EMBODIMENTS

The cable management safety systems of the instant invention contain at least the following required structural and functional elements combined as described herein below.
1. At least one, or a plurality, of approximately vertical supporting structure (having no more than about 45 degrees of deviation from vertical in any plane), cable support tower, or analogous element that is/are optionally equipped in the lower portion with a means to enable their safe mobility across floors, driveways, garages, parking lots, largely horizontal surfaces, and the like; the upper portions being optionally equipped with a means to support an electric cable and/or its connector in a safe manner.
2. At least one, or a plurality, of link(s) or element(s) that is/are connected to the vertical supporting structure(s) via at least one side of said link. They are optionally equipped with a means to support an electric cable and its connector in a safe manner. Either the vertical structure(s), or link(s), or both must have at least one means of electrical cable support between them. Link must be approximately horizontal (having no more than about 45 degrees of deviation from horizontal in any plane), and most of it must be located not more than about 2.0 meters (6.5 feet) above horizontal surface supporting the vehicle being charged, and preferably not more than about 1.8 meters (5.9 feet) above said surface.
3. A means of securing the electric cable's “free” end with its electrical connector to the structure(s) described herein in such a manner that in case of the plug being released, it will not impact the ground, floor, or any other largely horizontal surface and remain suspended in the space above it, thus eliminating one risk of user impact injury and preventing connector impact damage and/or contamination thereof. This is termed “drop safety”.
4. The assembly of parts above is capable of being arranged in a manner that prevents any part of the cable from contact with ground, floor, or other largely horizontal surface below the cable management system at all times (deployment, use, stowage).
5. The assembly of parts above is optionally capable of being arranged in a manner that allows for its compact storage/folding/moving out of the way and subsequent deploying/unfolding/moving into position to connect EV to a source of electricity by means of an electric cable supported by the assembly of parts.
6. The assembly of parts above optionally encloses the cable at least partially, or preferably encloses most of the cable to protect it from view, damage, snow, rain, solar radiation, vandalism, theft, etc.
7. The assembly of parts above optionally automatically stows itself and cable attached thereto when released; this feature's presence is preferred for safe equipment operation.
8. The assembly of parts operates entirely mechanically, with no electric or electronics components present.

### Vertical Supporting Structure(s).

Approximately vertical supporting structure, cable support tower, or analogous element of the instant invention may be stationary or can be equipped with wheel(s) or similar apparatus to enable it/them to easily be moved across surfaces encountered at common EV charging locations such as indoor and outdoor locations. It is preferred for mobile embodiments that the wheels be of a rotating caster type and equipped with lockable brakes so that after the mobile vertical support structure(s) are positioned/deployed as desired, they can be prevented from further movement until said movement is desired again (e.g. for stowage). The vertical structure(s) optionally may be of variable or adjustable height for user convenience and optimization of cable path efficiency in 3D space.

A wide range of cable support structures are well within the scope of the instant invention, both of fixed and mobile varieties. They can be a DC fast charger's or an AC EVSE's outer casing, wall(s), pole(s), column(s), bollard(s) or other suitable items. A separate fixed vertical element can also be affixed to aforementioned items as well. Vertical support elements may be of various heights, and their height can be optionally adjustable and variable; the EV charging cable does not necessarily need to be located at the top of a vertical element and can be attached at other suitable points thereon; the cable does not have to be attached to a vertical element directly or otherwise, if it is attached to a link instead. The cable may be attached with a suitable bracket, or rest on the internal structure of the cable support structure directly. The designs for achieving this can be any known to the art, including but not limited to telescopic, folding, locking, etc.

There can be more than one vertical support structure in a given embodiment, and each vertical structure may be freely chosen among all possible designs, especially when the cable's reach needs to be longer. It is also well understood that having a fixed vertical support structure “followed” by one or more mobile ones (beginning at EVSE or DC charger and ending at the connector on the cable) is well within the scope of the instant invention.

The materials of construction for vertical support structures can be any suitable to the application and known to the art of constructing equipment, including but not limited to: metals, alloys, polymeric materials, composites, wood and wood-derived products, etc. It is appreciated that electrically non-conductive structures can be especially useful in these applications (fiberglass, composites, polymer-containing materials, etc.), although they are not required. In addition to the above, utilization of suitable existing structures for this function, in whole or in part, regardless of their initial intended purpose (EVSE and DC charger casings, walls, columns, beams, bollards, etc.) when such can be accomplished safely is also part of the instant invention.

It is desirable that the elements employed are sufficiently strong and durable to support the cables' weight for extended periods of time at maximum extension in all expected climatic and weather conditions. It is preferred that the structures contain appropriate features to make them highly visible to users, nearby people, passers-by, children, vehicles and the like to prevent collisions, injuries, etc., and to enable easy visual location of these parts. Such features can include, but are not limited to, various reflective elements, fluorescent and luminescent elements, bright colors, suitable warning labels, warning and illuminating lights of all types, and assorted combinations of the above.

Similar materials and features to those discussed above can also be employed in the construction of link(s), as well as the means employed for securing the “free” end of the electric cable and its connector (drop safety).

### Link(s)

Link(s) or structure(s) that connect to approximately-vertical support structures are of two types. Each individual link must be approximately horizontal (having no more than about 45 degrees of deviation from horizontal in any plane). They all can be of fixed length or variable/adjustable length; the methods used for enabling the variable/adjustable length are not critical and can be any suitable ones and, in any combination, known to the art of mechanical engineering, such as pantographs, telescoping systems, folding systems, those with rotating joints, mechanical and other sliding mechanisms, assorted slide, track and/or rail systems, roller and/or wheel systems, etc. Link height above ground may be variable or fixed, but must be sufficient to prevent cable contact with the ground, floor or other horizontal surfaces near EV charging locations in all cases. Simultaneously, the link height should not exceed about 2.0meters (6.5 feet) above horizontal surface supporting the vehicle being charged, and preferably not more than 1.8 meters (5.9 feet) above said surface. They can be made with the same material(s) and feature(s) described above for vertical supporting structures; the methods for choosing such materials and designs are well known to those skilled in the art of mechanical engineering and design of structures. When the length of a particular link is sufficient, it can also be equipped with features to attach charging cable to it, to prevent both excessive length of unsupported cable and cable contact with the ground or the like. Further, it is important that the cable attachment point heights be mostly located approximately at the optimal heights, whether on vertical support structure(s), link(s) or a combination of both. Optimal heights of attachment points via brackets or the like for the cable are between approximately the height of the EV-mounted charging receptacle above the surface supporting the EV being charged and approximately the height of the charging cable at the outlet of EVSE, DC charger, or the like. It is important that the height of those points be within the limits set by the instant disclosure, and that the means of attachment comply with all relevant safety rules and regulations, as well as prevent excessive wear, damage and flexural stress to the cable being supported. Such means are well known to the art. It is required that they can be arranged to ensure that the cable being supported is moved in such a way during deployment, use and storage procedures that it does not touch the ground, road, or other largely horizontal surface in the vicinity of the charging system and EV being charged.

First type of link (end link) is located between a vertical cable support structure described above (wall, column, DC fast charger exterior casing, etc.) and the electric cable's “free” end with connector; it is preferred that such a link possess variable length and also at least two degrees of freedom of movement (e.g. variable length and variable angle relative to the vertical support structure via at least some rotation in the horizontal plane). This function can be enabled using a variety of suitable hinges, joints and the like well-known to the art of equipment construction. This type of link is connected to a vertical support structure on only one of its ends. This type of link must have a means for preventing contact of charging connector at the free end of cable with floor, operator's feet, and the like in case it's released (sometimes termed “drop safety”).

Second type of link (intermediate link) is located between two vertical support structures. This type is used mostly when there is a need for use of relatively longer cables, and can be fixed or preferably variable length. Variable length (functionality derived from systems selected from among end link construction options) is preferred for convenience in storage, compactness, ease of adjusting length to fit various vehicular charging connector locations indoors or outdoors, etc. This type of link is connected to two vertical support structures, one structure per side.

A vertical support structure can be “shared” between two different (or identical) links of any type. Further, a vertical support structure can be used to add a rotational degree of freedom of motion to the system. A combination of vertical support structures and links of various types can be used to provide a variable length and flexible path for an EV charging cable to conveniently reach a vehicle's charging receptacle. Such combinations are also highly useful because they can be made in a way that allows them to be folded and stowed in comparatively small spaces easily, quickly and conveniently, while at the same time causing relatively little flexural stress to the cable.

Vertical element(s) and/or link(s) may incorporate optional but preferred enclosures, housings, cable guards and similar features to help protect the cable and the system as a whole, as well as for aesthetics and safety reasons to prevent intrusion into the system. Link(s) (as opposed to vertical elements) incorporating substantially fully cable-enclosing features are especially preferred as part of this invention's embodiments for practical reasons of easier construction. Enclosures that conceal a significant part of the cable and/or structures of the instant invention, or preferably most of them also provide additional protection for the charging cable from a variety of deleterious events, such as solar radiation, theft, vandalism, snow, rain, animals, and others.

### Cable Attachment and Safety Elements

One of the critical functions of the devices of the instant invention is the prevention of user and bystander injury, as well as prevention of equipment contamination and/or damage due to uncontrolled impacts of electrical connector (or charging head) mounted to “free” cable end of the charging systems of all types. This is the “drop safety” system requirement of the instant invention. Other critical functions are the prevention of contact between the cable being employed and the nearby ground, pavement, etc. and prevention of excessive force application to charging cable that results in wear, damage, etc. during deployment, use and stowage.

While the specific means of achieving these functions for a variety of designs are obvious to one skilled in the art and are all within the scope of the instant invention, illustrative and non-limiting possibilities are discussed below.

Further, in selected embodiments, the various features of the instant invention (e.g. change in link length and/or height) may be automatic and powered either mechanically, by gravity, or other suitable means known to the art of equipment design and engineering such as various springs, weights, etc. The use of electronic systems for this purpose is outside the scope of the instant invention for a wide range of reasons, including but not limited to cost, complexity, decreased reliability, etc.

### Cable Attachment

Cable attachment points on the approximately vertical support structure(s), or link(s), or both can range from relatively simple to sophisticated. Their function is to maintain a connection between the structures and the charging cable and maintain it in position securely during system operation. Optionally, a variety of annular type structures attached to the cable may also be used for preventing undesirable longitudinal movement of charging cable within the cable management system's structure. Optionally but preferably, the systems of the instant invention can contain a variety of cable storage features internally; such features may employ pulleys, drums, weights, or any other devices known to the art of mechanical engineering for cable retraction and extension. Such devices are designed to function in ways that do not cause excessive loads or strains to the cable stored, retracted or extended by the system.

### Additional Invention Embodiments

The various additional embodiments of the instant invention and advantages of this type of system are easily appreciated by those skilled in the arts of EV charging equipment design, safety equipment design, ergonomics, and the like; therefore, the enumerations of these advantages herein are non-limiting, non-exhaustive, partial and illustrative only.

Using EV's and certain other vehicles as a source of power for homes, buildings, residences, construction sites, various establishments; operating electrically powered equipment at job sites and a variety of other applications where electricity is provided by a vehicle to systems outside of same are also known to the art, and advertised as an important feature by a number of EV and other vehicle manufacturers. This is often termed V2G, V2L, V2H and the like, for vehicle to grid, vehicle to load, and vehicle to home, respectively. Using the cable management systems taught and/or suggested herein is also useful for this application range, in addition to more traditional EV charging, because of similar issues related to handling of cables of significant length carrying large amounts of electrical energy. The optional minor changes and/or adaptations involved are obvious to one of skill in the art and do not need a separate description, but are well within the scope of the instant invention.

Additional structural features required by the instant invention but not explicitly described are understood by those skilled in the art of mechanical and structural engineering from the instant disclosure, but are discussed herein for clarity in a non-limiting and partial fashion.

An important element of one embodiment of the instant invention is the use of a suitably located existing column, wall, beam, housing, bollard, or the like as a vertical cable support element (or a part thereof) in constructing the devices of the invention. An important use of such features is to stabilize the cable-supporting structure against excessive unintended tilting, bending, flexing and the like that can occur when it is in use, especially when such use occurs outdoors and the device with its cable must resist wind and adverse weather conditions. It is appreciated that this approach for using existing structures for practice of the instant invention is a very effective cost-saving measure.

Another important aspect of certain embodiments of the instant invention is that embodiments of the instant invention having a relatively smaller “footprint” area are preferred because they are therefore more compact and take up less space and are more useful in applications where space for placement of charging cables is highly limited. They can then also be located in relatively narrow areas and avoid becoming tripping hazards themselves. A wide range of mechanical and structural arrangements is known to the art of engineering for achieving this, and they are all well within the scope of the invention.

### EXAMPLES

### Example 1

This system consists of a single fixed vertical support element that is attached to an existing wall, such as in a garage, parking structure, etc., and a single link of the first type with variable length functionality enabled via slide mechanisms. It has a mostly-enclosed cable and the rest of system for protection against elements, theft, etc., and an internal cable storage feature. The system has a cable drop safety integrated into the link that keeps the cable in a fixed position relative to the free end of the link. The system has two degrees of freedom of motion during use and three during assembly. During use, the degrees of freedom are rotation in the horizontal plane and extension/retraction of link. During assembly, the length of cable and plug combination protruding from the free end of the link can be varied as needed. This system further has an automatic retraction and folding features powered by spring mechanism for rotation, and by weight of movable pulley for retraction, so that when released it automatically retracts and stows itself at suitable rates. System is illustrated in states A and B, extended and retracted respectively. While it is depicted in a position that is perpendicular to the wall, it can be placed at any suitable angle to the wall and stows parallel to/along the wall. The system's total maximum usable reach is over 10 ft (3 meters). The amount of cable extension outside the system is adjustable by installer (depicted near maximum extension in drawings).

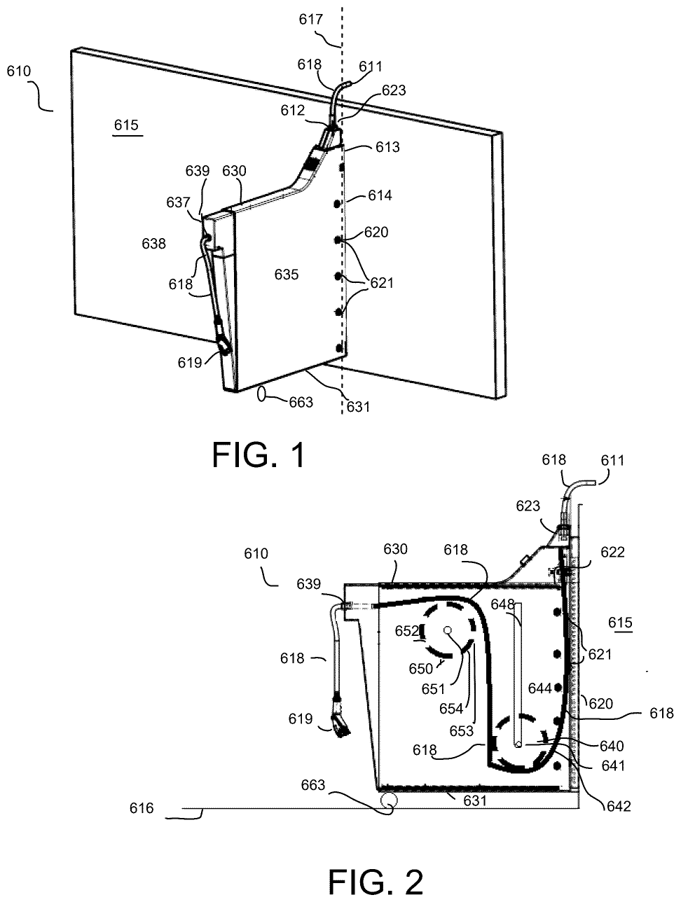

The cable mounts to a “sliding drawer” that holds the cable in place. The drawer mounts to horizontal slides that are covered (so no fingers can get caught in them). Conceptually related to a tall-and-narrow kitchen cabinet drawer, except the cable management system may be enclosed on 5 sides (back may be open). Building on FIGS. 1-2 and particularly Example N of PCTUS23-10616 (herein incorporated by reference), as shown in FIGS. 30-36 therein, a single vertical element (e.g., wall, column, DC charger housing, or a separate pole) and a single link 600 could be used to attach with rotating joints to a vertical wall or pole support 601 (optionally having internal return mechanisms for convenience). The link and the vertical support element, each, are designed to support the charging cable having very high weight typical of DC fast chargers using suitable brackets that prevent excessive cable strain and bending. The same brackets may also be used to prevent unsafe extension of cable's free end with its connector beyond intended distance and resulting risk of impact by plug to floor or user's foot (drop safety). The cable support brackets were shown attached to several different elements to illustrate some of the variety of possible solutions. A similar design with suitably lighter duty components could also be used for AC charging with an EVSE. As before, the exterior of the device may optionally be covered. Previously shown with perforated sheets, here shown with a horizontal telescoping drawer/slider mechanism. By using low-friction sliding elements equipped with cable supports, they conveniently retract automatically using the weight of link, connector and cable combination, and extend as needed by the user with relatively low effort. The outer covers are suitably connected to the link, to enable them to “telescope” as the device is extended and retracted. In this embodiment, the cable management system may be entirely separate from the cable origin. It is also capable of being easily folded for storage by collapsing the link, then folding it against a DC charger's housing or nearby wall. It may also be equipped with an optional receptacle for storing the charging plug via attachment to a link hardware element; visual safety markers are omitted in this photo for clarity.

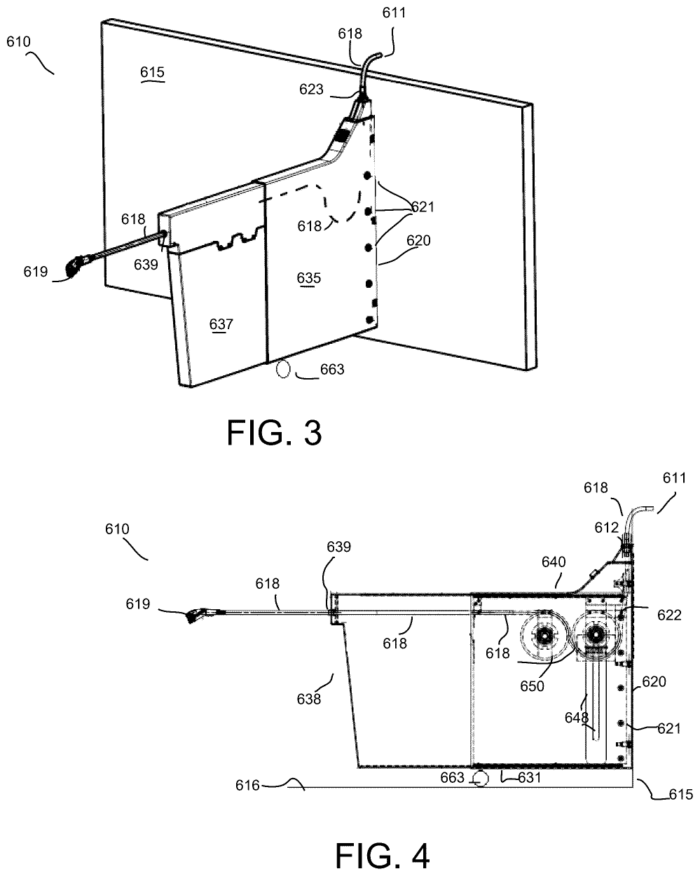

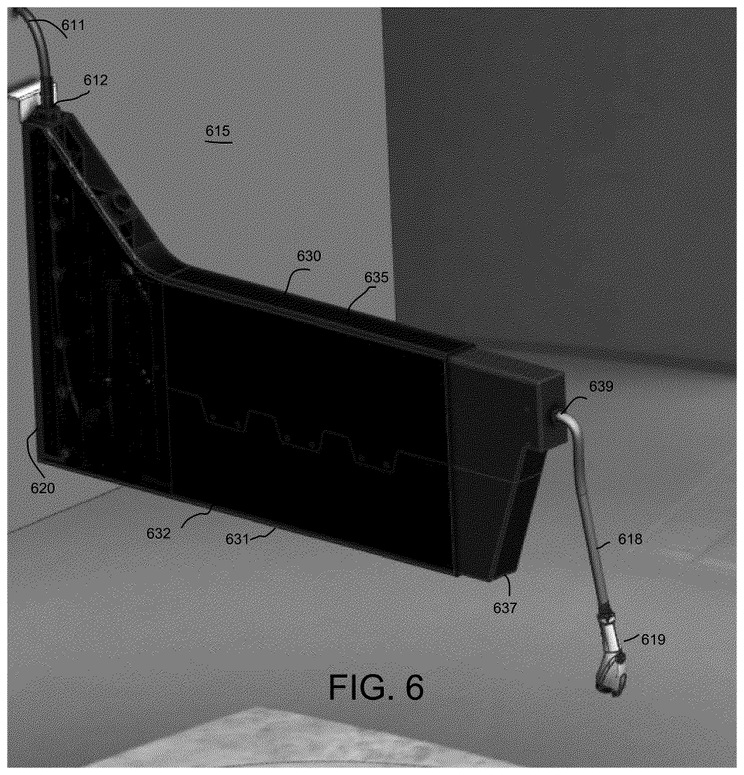

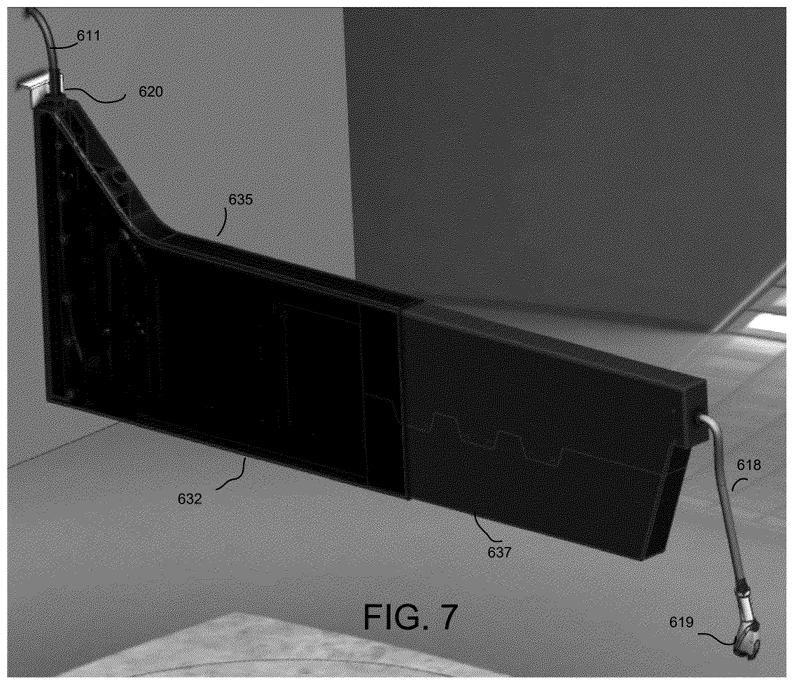

Here shown in Example 1 builds on and further defines the capabilities of such a cable management system. Example 1 is shown in FIGS. 1-7. The system is in extended mode in FIGS. 3,4, and 7, and FIGS. 1-2, 5 and 6 in contracted state. Extending body 637 preferably fits into fixed body 635, in a slidably engaging manner, preferably along a track, such that extending body fits into fixed body in telescoping fashion to allow the extending body to be pulled or extended out from fixed body. Fixed body is not fixed relative the wall, but is rather hinged in such a way that the cable management system includes a large arm, made of the fixed and extending bodies that can be rotated from flush with wall, as shown in FIG. 6, from wall to perpendicular as shown in FIGS. 1-4, 6-7, and preferably the range of the rotation of arm along hinge from wall is 180-degrees, to allow to fold in either direction, give or take 5-10 degrees (based on the manner in which the hinge is mounted to wall. Preferably bodies 635 and 637 are suspended above the ground or floor 616, such that the system is mounted only to the vertical wall. In some embodiments, a support, such as caster wheel 663, may be set along bottom surface of arm, preferably freely rotating as is known the art, and preferably towards lower far end of fixed body, to support weight against ground.

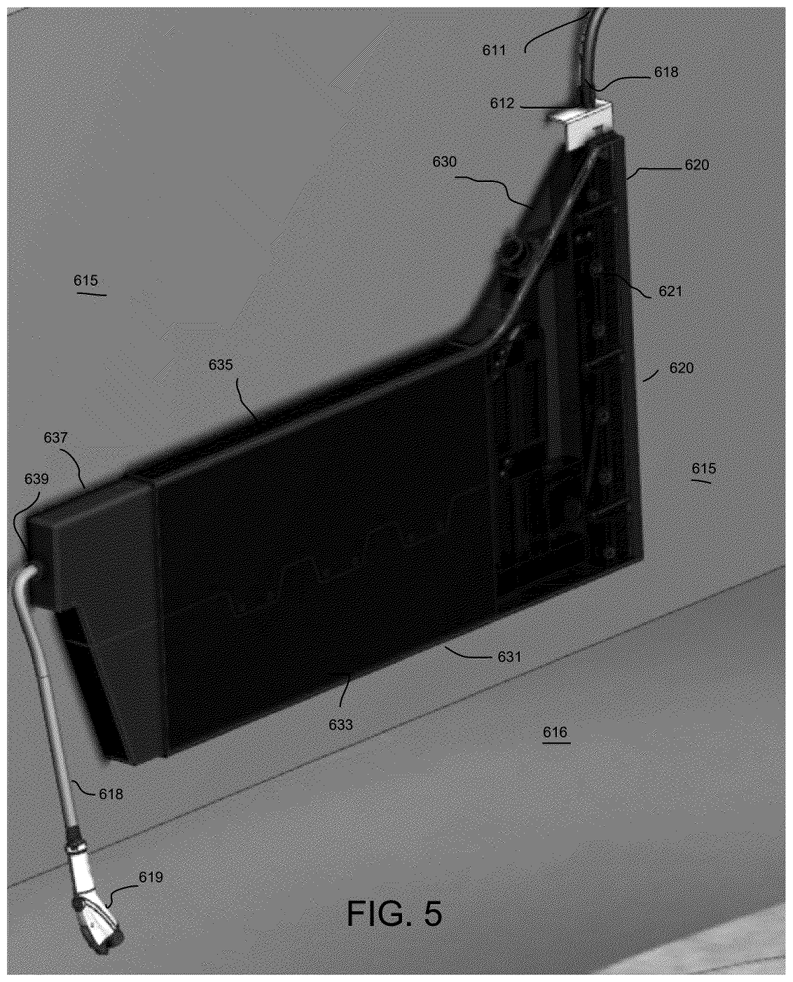

Cable management system 610 may be set on a support pole or wall mount 613. Cable or cord 618 may be set within wall 615 and lead to a cable power supply that may be within the wall, or elsewhere providing electrical power to the cable. Cable fits into cable management system 610 at top 630 via coupler 612. Top 630 may include a hump at or near wall mount 613 to provide for added space within the unit. Coupler preferably fixes the position along cable 618 between the system and the wall or cable supply. System 610 may be hinged to wall 615 via hinge 620 along axis 617 to allow, preferably 180-degree (or nearly 180-degree) rotation against flat wall surface (give or take 10-degrees depending on how flush the axis is relative the wall and the width of system. System 610 maintains and suspends cable 618 above floor 616, even when in contracted state (see FIGS. 1-4). As shown, FIG. 2 demonstrates a partial see-through version to allow view of cord 618, even though it is preferable that side walls shield protect and cover cord (as shown in FIGS. 5-7). FIG. 3 shows the location of cord 618 within fixed body 635 as it would follow path by internal spools (not shown in FIG. 3). Cord and spools (and other internal mechanics) are shown in FIGS. 2 and 4 for demonstrable purposes. The cord 618 may extend from far side 638 (near top) of system along extending body 638. Preferably, cord length beyond outer coupler 639 is fixed such that cord length 618′ prevents the cord from touching ground, resting on ground, and prevents charging head 619 from reaching ground or swinging too much.

Fixed body 635 (coupled to the hinge, is preferably of a fixed length and has one end fixed relative the axis. The extending body may slide as a drawer horizontally relative to the fixed body from extended state (as shown in FIGS. 3-4) and contracted state (as shown in FIGS. 1-2).

Fixed body is mounted to wall mount 613 along axis 617. Hinge 620 may couple the fixed body to wall mount 613 via fasteners 621. Cable 618 may enter from wall supply into system 610 through inner coupler 623 to fix the relative position along the cord with the wall supply. In some embodiments, the length of cord provided may be adjusted at inner coupler to provide more or less cord to system. Guide 622 is preferably positioned internally within the fixed body to guide the cord under first spool 640. Spool 640 preferably includes a rounded disc-like body with a perimeter 642 including a channel 644, preferably bound by sloping sidewalls or flanges 643 forming a channel along perimeter as is known in the art. The spool (and second spool 650) may or may not be free to rotate, or one or both may be fixed to prevent rotation along first spool axis 641 and second spool axis 651, respectively.

Second spool 650 may be set, and is preferably fixed within fixed body 635, preferably towards top. Second spool 650 similarly has an axis 651 and is preferably spool or disc-shaped (as first spool) with a perimeter 652, and channel 654 formed with flanges 653 as is known in the art. Cord 618 is preferably run into fixed body 635 through coupler 623 and set through guide 622 routed under first spool 640 (considering cord as from the power source/wall), and then over second spool 650, and then out outer coupler 639 to provide for power to EV.

Cable management system may begin in contracted state, as is shown in FIGS. 1-2, with the 1st spool set in a low position. First spool is preferably either spring biased or weighted to drop down and maintain tension in cord when in contracted state. The weight (of first spool) or a spring may help contract the system, and bias it to close (retract) when not in use. When the system is in contracted state, the first spool may be drawn downward to retain tension in cord.

Similarly, when extended by extending body, the first spool may be lifted to allow cord to extend effective length to reach the charging target (e.g., EVSE). First spool may drop vertically within a vertical channel 648 built into the internal body of fixed body, preferably via extending bosses, or pins at first spool axis 641 extending into vertical channel, thus maintain the horizontal position of the first spool and prevent freely moving withing fixed body outside vertical channel.

It is contemplated that cable management system may be able to rotate on axis 617 when in contracted, or extended state, or anywhere between.

As shown in FIGS. 5-7, the system may include left and right sides 632 and 633, respectively, whereby fixed body 635 and extending body 637 are effectively closed to prevent unwanted access to cord. Extending body preferably fits within and slides horizontally into fixed body in a telescoping fashion, as shown and as known in the art. While less preferable, extending body may fit outside fixed body. Length of free end 655 f cord 618 off of far side 638 out of coupler 639 is preferably fixed, allowing the length of cord 655 to hang, but remain well-above the ground level to prevent charging head 619 from making contact physically, or even magnetically/electrically to avoid spark or an electric arc with the floor or any small item set thereon. Fixed and extending body, as well as many other parts (e.g., spool, guides, etc.) are preferably made from non-conducting materials.

We claim:

1. A system for electric energy transfer by means of at least one electrical conductor having improved safety, utility and convenience features comprising a means of conducting electricity such as via a suitable cable and its cable management system; said cable management system comprising:
a fixed body, hingedly coupled to a vertical support via a hinge having a hinge axis;
an extending body slidably coupled with said fixed body;
a cord set into the fixed body and passing out of said extending body, said cord comprising a charging coupler at a far end extended out of the extending body.

2. The system of claim 1 wherein said fixed body comprises a first spool with a first axis orthogonal the hinge axis.

3. The system of claim 2 wherein said fixed body further comprises a second spool with a second axis orthogonal said hinge axis and parallel said first axis.

4. The system of claim 3 wherein said cord is set below the first spool and routed above the second spool.

5. The system of claim 4 wherein said first spool is free to drop along a vertical route within said fixed body.

6. The system of claim 5 wherein said first spool is slidably engaged into a vertical channel within the fixed body.

7. The system of claim 6 wherein said first spool is biased downward.

8. The system of claim 4 wherein the system comprises a contracted state wherein the first spool is positioned in a low position within the fixed body, and an extended state wherein the first spool is in a position higher than said low position.

9. The system of claim 2 wherein said extending body comprises a second spool with a second axis orthogonal said hinge axis and parallel said first axis.

10. The system of claim 9 wherein said cord is set below the first spool and routed above the second spool.

11. The system of claim 1 wherein said fixed body is free to rotate horizontally relative the vertical support along hinge axis.

12. The system of claim 1 wherein said cord comprises a free end fixed at one end relative the extending body, said free end terminating is said charging coupler.

13. The system of claim 12 wherein said free end comprises a length that is less than a distance from a location at which the free end is fixed to the extending body and a floor below said system.

14. A method of supporting a charging cable above the ground, said method comprising the steps of:
hingedly coupling a fixed body to a vertical support via a hinge having a hinge axis;
slidably coupling an extending body with the fixed body;
setting a cord set in and through the fixed body and passing out of the extending body;
whereby the cord includes a charging coupler at a far end extended out of the extending body.

15. The method of claim 14 further comprising the step of fixing a length of free end of cord at a far end of the extending body.

16. The method of claim 15 whereby the length of the free end of the cord is less than the height of a coupler fixing a relative height of a cord outlet from the extending body.

17. The method of claim 14 comprising the step of storing the cord via rotating the fixed and extending ends along the hinge axis to place the fixed body flush with a wall.

18. The method of claim 17 further comprising the step of displaying the cord via rotating the fixed and extending bodies in unison away from the wall.

19. The method of claim 18 further comprising the step of sliding the extending body away from the wall.

20. The method of claim 19 whereby said step of sliding does not alter a length of free end of cord emanating from the extending body.
